(19) United States
(12) Patent Application Publication
(10) Pub. No.: US 2002/0008876 A1
(43) Pub. Date: Jan. 24, 2002

(54) Stray light barrier structure of reflection measuring apparatus

(76) Inventors: Takekazu Terui, Tokai-shi (JP); Tetsumasa Kawaguchi, Kariya-shi (JP); Yoshiaki Hoashi, Kariya-shi (JP)

Correspondence Address: LAW OFFICE OF DAVID G POSZ, 2000 L STREET, N.W., SUITE 200, WASHINGTON, DC, 20036, US

(21) Appl. No.: 09/897,063

(22) Filed: Jul. 3, 2001

(30) Foreign Application Priority Data
Jul. 19, 2000 (JP) 2000-219111

(51) Int. Cl. G01N 21/55

(52) U.S. Cl. 356/445

(57) ABSTRACT

A reflection measuring apparatus such as a laser radar is provided which emits a laser beam using a scanner and receives a return of the laser beam from an object present in a scan range to obtain positional information about the object. The apparatus includes a stray light blocking plate which has a beam exit opening formed on an optical path along which the laser beam travels from a light source to the scanner. The stray light blocking plate has a barrier wall defined around the beam exit opening which works to interrupt traveling of the stray light produced optically upstream of the beam exist opening to the scanner. The barrier wall has a surface which tapers off in cross section thereof to the beam exist opening, thereby minimizing reflections of the stray light on an inner surface of the barrier wall defining the beam exit opening to the scanner.

### BACKGROUND OF THE INVENTION

1. Field of the Invention

The present invention relates generally to an improved structure of a reflection measuring apparatus such as a radar designed to scan a beam to detect an object present in a scan range, and more particularly to a stray light barrier structure of a reflection measuring apparatus which blocks emission of the stray light to avoid the leakage thereof outside the reflection measuring apparatus.

2. Background Art

Optical reflection measuring apparatuses are known which are designed to emit a light beam over a given scan range and receive a return of the beam to obtain information (e.g., an angular direction) about a reflective object present in the scan range. Such optical reflection measuring apparatuses are employed, for example, in automotive alarm systems working to detect a sign post, a preceding vehicle, or a white line on a road and sound an alarm when a system vehicle is approaching the sign post, coming into a collision with the preceding vehicle, or going outside the white line.

Optical reflection measuring apparatuses of the above type usually emit stray light such as light scattered or reflected on a surface of an optical element or on inner structural elements of the apparatus in addition to a light beam used to detect an object. Stray light minimizing measures are already used, however, with an increasing need for the improvement of optical sensitivity, an error in detecting an object existing out of an optical axis caused by the stray light will increase.

For instance, if the stray light, as shown in FIG. 7, is emitted from a reflecting measuring apparatus in a direction shifted from a main beam, it may cause the reflecting measuring apparatus to receive as an optical noise a return of the stray light from an object existing at a distance from the main beam. This will result in an error in an operation of, for example, an alarm system equipped with such a reflection measuring apparatus. Such a problem is encountered, especially when an object on which the stray light hits has a higher reflectivity. For example, typical automotive vehicles have a reflector installed on a rear end thereof which reflects the stray light at a stronger level which will give rise to the above problem.

### SUMMARY OF THE INVENTION

It is therefore a principal object of the invention to avoid the disadvantages of the prior art.

It is another object of the invention to provide a reflection measuring apparatus which is designed to have a stray light barrier structure working to avoid leakage of the stray light outside the apparatus.

According to one aspect of the invention, there is provided a reflection measuring apparatus such as a laser radar. The reflection measuring apparatus comprises: (a) a light source producing a light beam; (b) a scanner directing the light beam produced by the light source to a given scan range to detect an object therein; (c) an optical receiver receiving a reflection of the light beam from the object within the scan range to obtain preselected information on the object; and (d) a stray light blocking member having a beam exit opening formed on an optical path along which the light beam travels from the light source to the scanner. The stray light blocking member has a barrier wall defined around the beam exit opening which works to interrupt traveling of stray light produced optically upstream of the beam exist opening to the scanner. The barrier wall has a surface which tapers off in cross section thereof to the beam exist opening.

In the preferred mode of the invention, the tapered surface of the barrier wall faces the scanner.

An angle which the tapered surface makes with the optical path of the light beam extending through the beam exit opening is greater than an angle which an outer periphery of the light beam makes with the optical path.

A structural element holding member is further provided which holds a given structural element of the reflection measuring apparatus. The structural element holding member has a beam exit opening through which the light beam produced by the light source passes. The beam exit opening of the structural element holding member is formed optically upstream of the beam exit opening of the stray light blocking member.

According to another aspect of the invention, there is provided a reflection measuring apparatus which comprise: (a) a light source producing a light beam; (b) a scanner directing the light beam produced by the light source to a given scan range to detect an object therein; (c) an optical receiver receiving a reflection of the light beam from the object within the scan range to obtain preselected information on the object; and (d) a stray light blocking member having a beam exit opening formed on an optical path along which the light beam travels from the light source to the scanner. The stray light blocking member has a barrier wall defined around the beam exit opening which works to interrupt traveling of stray light produced optically upstream of the beam exist opening to the scanner. The barrier wall spreads in cross section in an advancing direction of the light beam at an angle greater than a spread angle of the light beam.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an exploded view which shows a reflection measuring apparatus according to the present invention;

FIG. 2 is a sectional illustration as viewed from the top of the reflection measuring apparatus of FIG. 1;

FIG. 3 is a sectional illustration as viewed from the right side of the reflection measuring apparatus of FIG. 1;

FIG. 4(a) is a sectional view which shows a stray light barrier structure;

FIG. 4(b) is a sectional view which shows a relation between a beam exit opening and a laser beam;

FIG. 4(c) is a sectional view which shows a modification of a stray light barrier structure;

FIG. 5 is a sectional view which shows a comparative example of an optical system;

FIG. 6 is an explanatory view which shows stray light blocking effects provided by a structure of the invention; and

FIG. 7 is an illustration for explanation of a stray light-caused measurement error encountered in a conventional automotive radar system.

### DESCRIPTION OF THE PREFERRED EMBODIMENTS

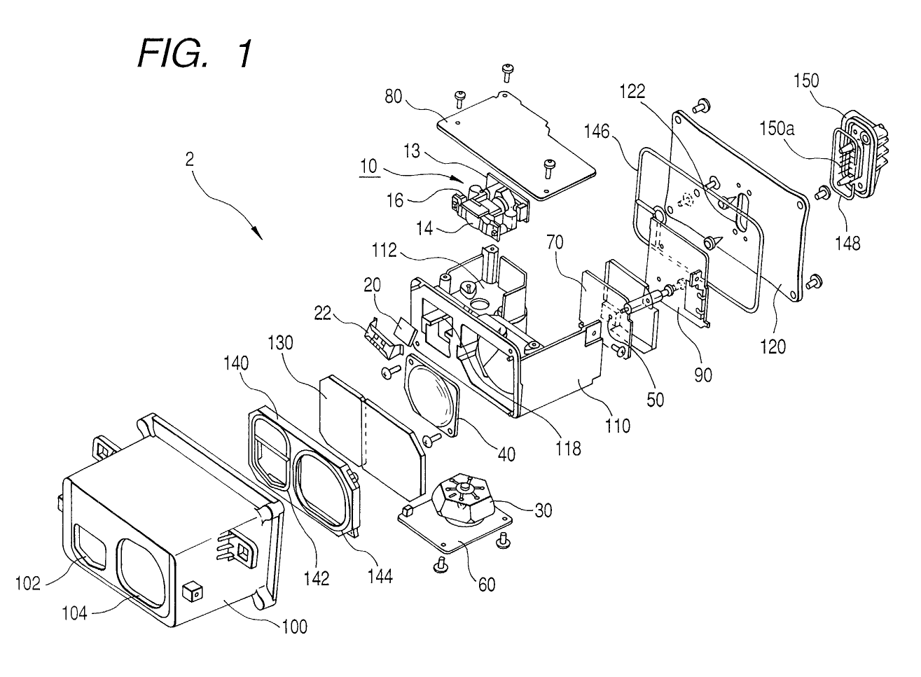

Referring to the drawings, wherein like reference numbers refer to like parts in several views, particularly to FIGS. 1 to 3, there is shown a reflection measuring apparatus 2 according to the present invention which will be discussed below as an example as used in a radar system of an automotive vehicle which emits a laser beam in an advancing direction of the vehicle and receives a return of the laser beam from an object to obtain information on the object such as an angular direction thereof.

The reflection measuring apparatus 2 includes an optical system consisting of a lens unit 10, a reflecting mirror 20, a polygon mirror 30, and a light-receiving lens 40. The lens unit 10 works to produce a parallel laser beam to the reflecting mirror 20. The reflecting mirror 20 directs the laser beam from the lens unit 10 to the polygon mirror 30. The polygon mirror 30 works as a scan mechanism which radiates the laser beam over a given scan range. The light-receiving lens 40 captures a return of the laser beam from the scan range.

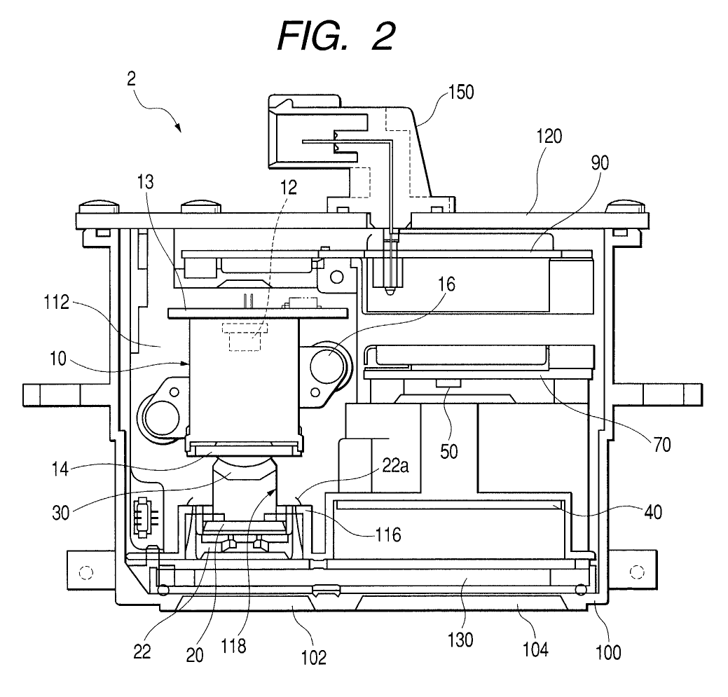

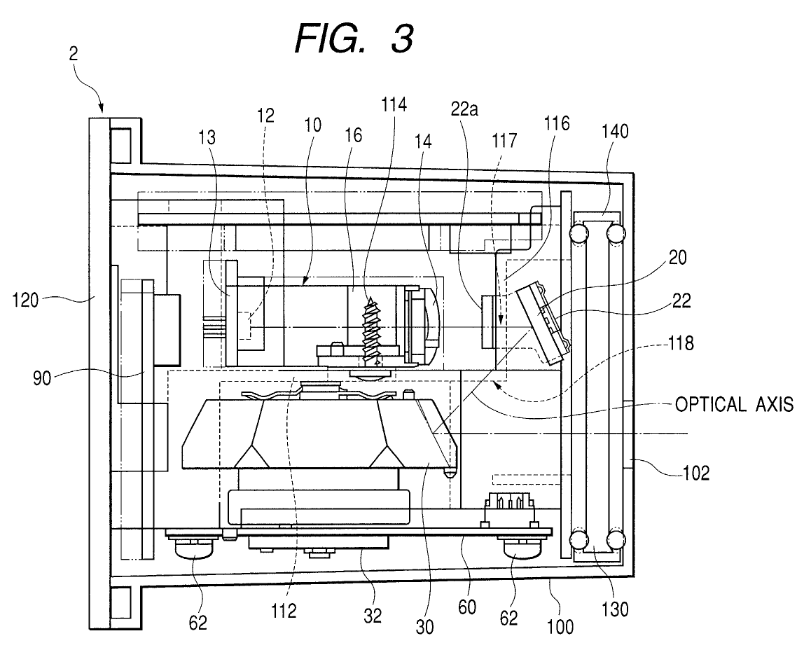

The lens unit 10 includes, as shown in FIGS. 2 and 3, a laser diode 12, a diode driver 13, a collimating lens 14, a unit casing 16. The diode driver 13 supplies the power to the laser diode 12 to emit a laser beam in an infrared region in the form of a pulse. The collimating lens 14 receives the laser beam from the laser diode 12 and outputs a parallel beam. The unit casing 16 retains therein the laser diode 12, the diode driver 13, and the collimating lens 14 so as to direct the laser beam from the laser diode 12 to the collimating lens 14.

The reflection measuring apparatus 2 also includes, as shown in FIG. 1, a motor driver 60, an optical processing circuit 70, a control circuit 80, and a power supply circuit 90. The motor driver 60 actuates a polygon scanner motor 32, as shown in FIG. 3, to turn the polygon mirror 30. The optical signal converter 70 includes a photo diode 50 which converts an input light into an electric signal and adjusts the electric signal in amplitude and waveform to provide an optical signal. The control circuit 80 actuates electronic components of the diode driver 13 and motor driver 60 to perform a scanning operation of the optical system and analyzes the optical signal from the optical signal converter 70 to determine the position and relative speed of an object present in the scan range (i.e., a radar detectable range). The power supply circuit 90 supplies the power to electronic components installed in the diode driver 13, the motor driver 60, and the control circuit 80.

The reflecting measuring apparatus 2 also has a physical structure for retaining and protecting the above component parts which consists of a front casing 100, an inner casing 110, and a rear plate 120. The inner casing 110 is disposed in the front casing 100. The rear plate 120 is installed on the front casing 100 to close an opening thereof.

The front casing 100 has an exit window 102 and an entrance window 104 formed in a front wall thereof. The laser beam from the polygon mirror 30 is radiated from the exit window 102. A return of the laser beam enters the entrance window 104. A protective plate 130 is installed on an inner front wall of the front casing 100 through a sealing member 140 to close the exit and entrance windows 102 and 104 for avoiding the ingress of dust and water into the front casing 100. The protective plate 130 is made of, for example, a transparent glass or resin without interrupting light.

The sealing member 140 has O-rings 142 and 144 formed integrally therewith which are attached to the periphery of the exit and entrance windows 102 and 104, respectively. The O-rings 142 and 144 are made of rubber and have substantially the same shapes as those of the exit and entrance windows 102 and 104, respectively. The O-rings 142 and 144 are pressed by the front of the inner casing 110 against the inner front wall of the front casing 100 to establish a hermetic seal between the protective plate 130 and the exit and entrance windows 102 and 104.

Disposed between the front casing 100 and the rear plate 120 is an O-ring 146 to seal a gap between the front casing 100 and the rear plate 120 hermetically for avoiding the ingress of water. A connector 150 is installed on an outside wall of the rear plate 120 which provides a connection of the reflecting measuring apparatus 2 with an external device for establishing transmission of a signal therebetween and supply of power to the reflecting measuring apparatus 2. The connector 150 has connection pins 150a. The connection pins 150a pass through holes 122 formed in the rear plate 120 and enter inside the reflecting measuring apparatus 2. An O-ring 148 is disposed between the connector 150 and the rear plate 120 to seal a gap between the rear plate 120 and the connector 150 hermetically for avoiding the ingress of water into the reflection measuring apparatus 2 through the holes 122.

The lens unit 10, the reflecting mirror 20, the polygon mirror 30, the light-receiving lens 40, the diode driver 13, the motor driver 60, the optical signal converter 70, the control circuit 80, and the power supply circuit 90 are retained by the inner casing 110 within the reflection measuring apparatus 2. The lens unit 10, the reflecting mirror 20, and the polygon mirror 30 are, as clearly shown in FIG. 2, arranged at the right side of an inner space of the reflection measuring apparatus 2.

Specifically, the right inner space of the reflecting measuring apparatus 2 is, as shown in FIG. 3, separated by a partition wall 112 provided on the inner casing 110 into upper and lower chambers. Within the upper chamber, the lens unit 10 and the reflecting mirror 20 are disposed on the partition wall 112. Within the lower chamber, the polygon mirror 30 is disposed. The partition wall 112 also serves as a barrier, as will be described later in detail, which shuts the stray light in the upper chamber to avoid leakage of the stray light outside the reflection measuring apparatus 2.

The lens unit 10 is secured on an upper surface of the partition wall 112 using a tapping screw 114 screwed into the unit casing 16 through the partition wall 112. The reflecting mirror 20 is located ahead of the lens unit 10 and retained on the inner casing 110 through a mirror holder 22. The inner casing 110 has a mirror mount wall 116, as shown in FIGS. 2 and 3, to which the mirror holder 22 is attached. The mirror holder 22 has a spring 22a which is fitted in the mirror mount wall 116 to nip the reflecting mirror 20 between itself and the mirror mount wall 116.

The mirror mount wall 116 has formed therein a beam exit opening 117 through which the laser beam passes. The polygon mirror 30 is installed on an output shaft of the polygon scanner motor 32 secured on a metallic base (i.e., a substrate) of the motor driver 60. The base of the motor driver 60 is secured on the inner casing 110 using screws 62.

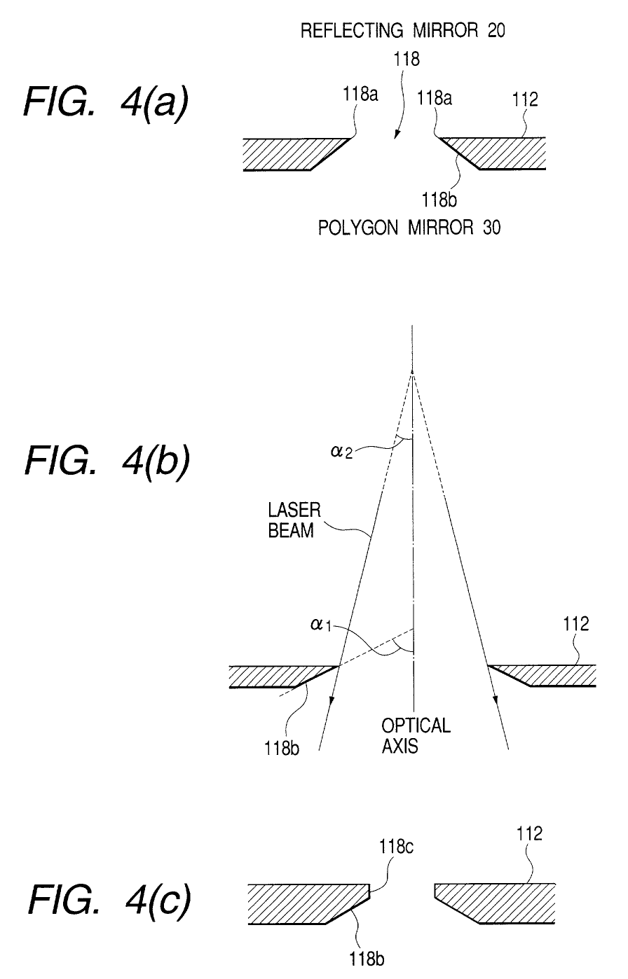

The partition wall 112 has formed therein, as shown in FIGS. 2 and 3, a beam exit opening 118 through which the laser beam reflected from the reflecting mirror 20 travels toward the polygon mirror 30. The periphery of the beam exit opening 118, as clearly shown in FIG. 4(a), is wedge-shaped to have a sharp edge 118a. Specifically, the partition wall 112 has a tapered surface 118b which faces the polygon mirror 30 and serves as a stray light barrier. The angle α₁, as shown in FIG. 4(b), which a line extending parallel to the surface 118b of the partition wall 118 makes with an optical axis along which the laser beam reflected from the reflecting mirror 20 travels toward the polygon mirror 30 is set greater than the angle α₂ which the outer periphery of the laser beam makes with the optical axis (i.e., half a spread angle of the laser beam). Note that FIGS. 4(a) and 4(b) are cross sectional views taken by a plane containing the optical axis extending between the reflecting mirror 20 and the polygon mirror 30.

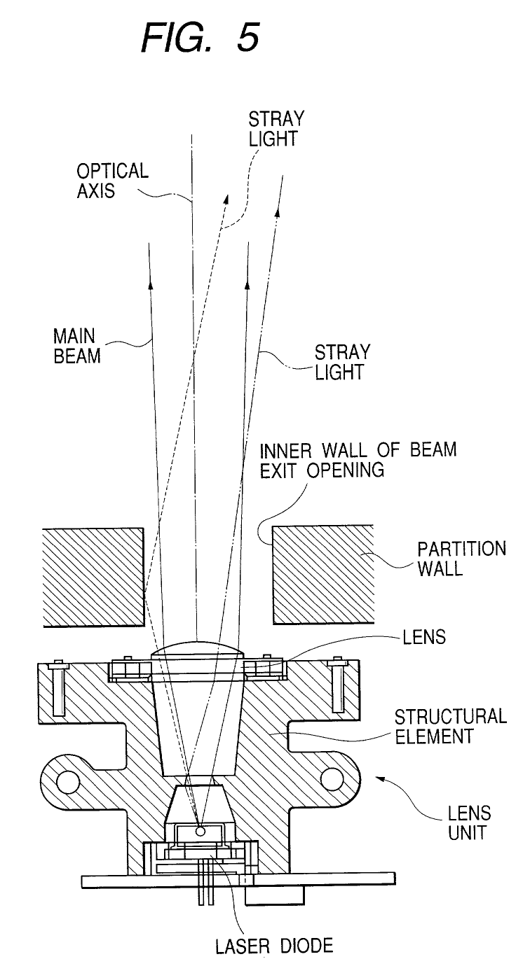

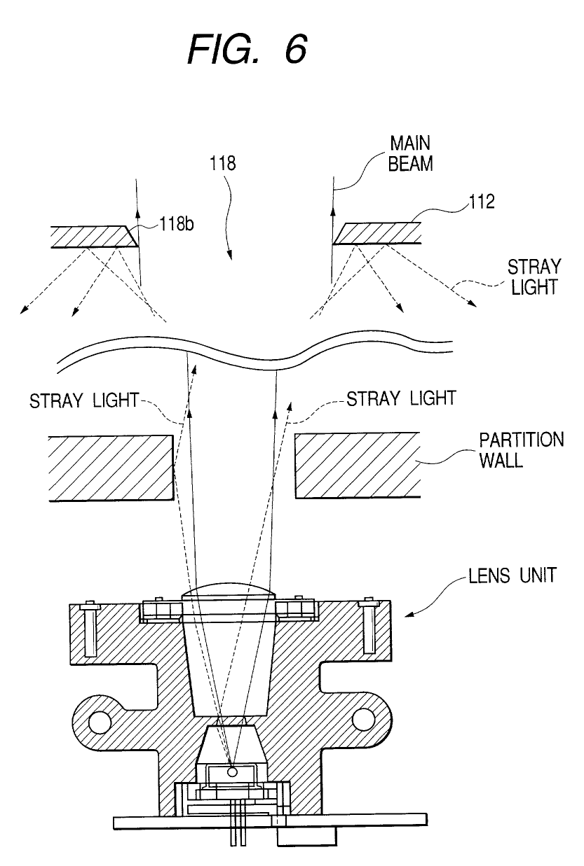

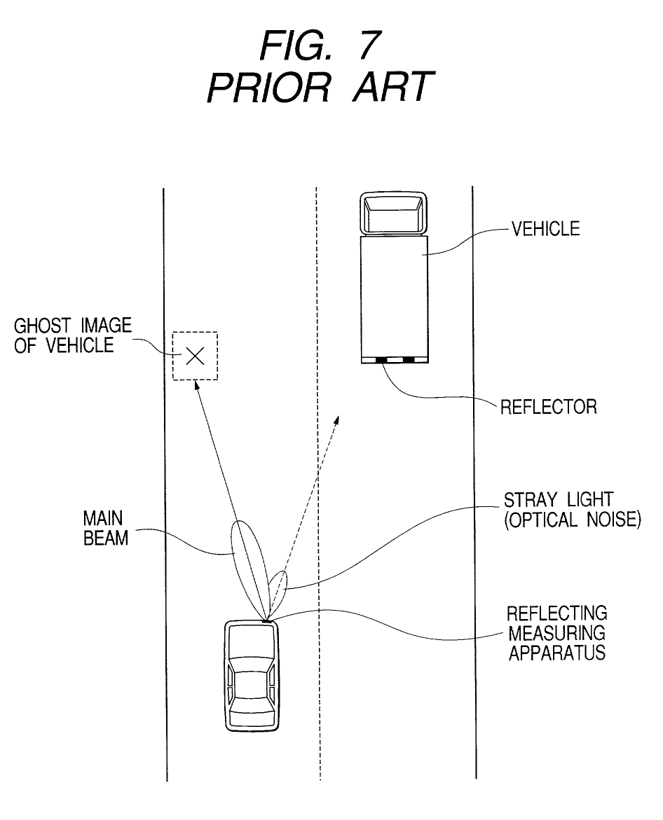

If a beam exit opening is, as shown in FIG. 5, defined by a flat inner surface formed in a partition wall substantially in parallel to the optical axis along which a laser beam emitted from a laser diode travels, the stray light arising from reflection or scattering of the laser beam on a surface of a structural element disposed between the laser diode and a lens may reflect on the inner surface of the partition wall so that it is outputted as a noise beam. Additionally, the main beam (i.e., a parallel laser beam emerging from the collimating lens 14) may also reflect on the inner surface of the partition wall so that it is outputted outside the partition wall as the stray light. The partition wall 112 of this embodiment, as described above, has the tapered surface 118b oriented outward (i.e., in an advancing direction of the laser beam). The stray light emerging from the lens unit 10 is, thus, reflected, as indicated by broken lines illustrated in an upper portion of FIG. 6 by the inner surface of the partition wall 112 without being reflected outward by the surface 118b of the partition wall 112, thereby avoiding the leakage of the stray light outside the reflection measuring apparatus 2.

The surface 118b of the partition wall 112 may alternatively be oriented toward the reflecting mirror 20. In this case, however, a portion of the laser beam traveling from the reflecting mirror 20 may reflect on the surface 118b to produce the stray light. It is, thus, advisable that the tapered surface 118b of the partition wall 118 be oriented outward to minimize a hit of the laser beam on the tapered surface 118b.

The angle α₁ which the tapered surface 118b of the partition wall 118 makes with the optical axis is, as described above, greater than the angle α₂ which the outer periphery of the laser beam makes with the optical axis. Specifically, the surface 118b of the partition wall 118 spreads at an angle greater than the spread angle of the laser beam in an advancing direction of the laser beam. This minimizes hits of the laser beam on the surface 118b, thus avoiding emission of the stray light substantially in the same direction as that in which the laser beam outputted from the reflection measuring apparatus 2.

In operation, when the reflection measuring apparatus 2 is turned on, the laser diode 12 emits a parallel laser beam through the collimating lens 14 in the form of a pulse. The laser beam travels to the reflecting mirror 20 through the beam exit opening 117 formed on the mirror mount wall 116. The laser beam reflected by the reflecting mirror 20 reenters the beam exit opening 117 and travels to the polygon mirror 30 through the beam exit opening 118 formed in the partition wall 118. The laser beam falling on the polygon mirror 30 is reflected by one of facets thereof and outputted from the exit window 102 of the front casing 100 for scanning the scan range defined ahead of the system vehicle equipped with the reflection measuring apparatus 2. If there is an object within the scan range, the laser beam is reflected thereby, so that a return of the laser beam enters the reflection measuring apparatus 2 through the entrance window 104. The laser return then passes through the protector plate 130 and travels to the photo diode 50 through the light-receiving lens 40. The photo diode 50 converts the input beam into an electric signal and outputs it as an optical signal. The laser beam emitted from the lens unit 10 is, as described above, a pulse beam. The positional information on the object (i.e., the distance between the object and the reflection measuring apparatus 2, the angular direction of the object, etc.) may, thus, be determined based on an emission timing of the laser beam and the time interval between transmission of the laser beam and reception of the echo.

The partition wall 112 is, as described above, provided on the optical path along which the laser beam emitted from the lens unit 10 travels to the polygon mirror 30. The partition wall 112 has formed therein the beam exit opening 118 through which the laser beam passes. The periphery of the beam exit opening 118 tapers off to the beam exit opening 118 so as to form the surface 118b oriented toward the polygon mirror 30, thereby preventing the stray light from being reflected on the polygon mirror 30 outside the reflection measuring apparatus 2, thus resulting in a decrease in error in detecting an object.

The mirror mount wall 116 has formed therein the beam exit opening 117 through which the laser beam produced by the lens unit 10 passes twice. There is, thus, a high possibility that the stray light will be produced when the laser beam passes through the beam exit opening 117. However, the partition wall 118 is located optically downstream of the mirror mount wall 116 and thus shields the polygon mirror 30 against the stray light effectively.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For example, the partition wall 112 is formed integrally with the mirror mount wall 1 16, but they may be provided separately. The lens unit 10 is carried on the partition wall 112, but may alternatively be retained by another structural member. The tapered surface 118b of the partition wall 112 has, as shown in FIG. 4(a), the sharp edge 118a, but may have a small flat end 118c, as shown in FIG. 4(c), extending parallel to the optical axis.

What is claimed is:

1. A reflection measuring apparatus comprising:
a light source producing a light beam;
a scanner directing the light beam produced by said light source to a given scan range to detect an object therein;
an optical receiver receiving a reflection of the light beam from the object within the scan range to obtain preselected information on the object; and
a stray light blocking member having a beam exit opening formed on an optical path along which the light beam travels from said light source to said scanner, said stray light blocking member having a barrier wall defined around the beam exit opening which works to interrupt traveling of stray light produced optically upstream of the beam exist opening to said scanner, the barrier wall having a surface which tapers off in cross section thereof to the beam exist opening.

2. A reflection measuring apparatus as set forth in claim 1, wherein the tapered surface of the barrier wall faces said scanner.

3. A reflection measuring apparatus as set forth in claim 2, wherein an angle which the tapered surface makes with the optical path of the light beam extending through the beam exit opening is greater than an angle which an outer periphery of the light beam makes with the optical path.

4. A reflection measuring apparatus as set forth in claim 1, further comprising a structural element holding member which holds a given structural element of the reflection measuring apparatus, said structural element holding member having a beam exit opening through which the light beam produced by said light source passes, the beam exit opening of said structural element holding member being formed optically upstream of the beam exit opening of said stray light blocking member.

5. A reflection measuring apparatus comprising:
a light source producing a light beam;
a scanner directing the light beam produced by said light source to a given scan range to detect an object therein;
an optical receiver receiving a reflection of the light beam from the object within the scan range to obtain preselected information on the object; and
a stray light blocking member having a beam exit opening formed on an optical path along which the light beam travels from said light source to said scanner, said stray light blocking member having a barrier wall defined around the beam exit opening which works to interrupt traveling of stray light produced optically upstream of the beam exist opening to said scanner, the barrier wall spreading in cross section in an advancing direction of the light beam at an angle greater than a spread angle of the light beam.
